(19) United States
(12) Patent Application Publication
(10) Pub. No.: US 2011/0220229 A1
(43) Pub. Date: Sep. 15, 2011

(54) WATER SUPPLY APPARATUS OF HYDROTHERAPY SYSTEM

(76) Inventors: SHIH-CHANG CHEN, Hukou Township (TW); Tsair-Rong Chen, Hukou Township (TW); Chih-Hsiang Chen, Hukou Township (TW)

(21) Appl. No.: 12/722,499

(22) Filed: Mar. 11, 2010

(51) Int. Cl. F15D 1/00

(52) U.S. Cl. 137/624.11

(57) ABSTRACT

A water supply apparatus of a hydrotherapy device is disclosed. The water supply apparatus includes a motor, a control module, a pressure switch, an ozone module, a first magnetic valve, a second magnetic valve, and a water outlet module. The control module is for driving the motor to retrieve water, and for turning the first magnetic valve and the second magnetic valve on or off and for determining the release of ozone. And by controlling the on/off of the magnetic valves, the operation mode of the water supply apparatus, such as a spa mode and a micro-bubble mode, is changed. Additionally, the control module further includes a leakage detection unit and an overload detection unit, in order to detect a power leakage and a power overload.

### BACKGROUND OF THE INVENTION

1. Field of the Invention

The present invention is related to a water supply apparatus of a hydrotherapy device, especially to a water supply apparatus with superior safety protection and with the capability of switching among different water output modes.

2. Description of the Related Art

More and more modern people have been becoming more and more vulnerable to increasing psychological stresses. Thus, they choose to turn to leisure centers for hydrotherapy including muscle massage by applying pressurized water flow onto human body.

However, the quality of water flow used in the spa leisure center is hardly controllable. If the water used for muscle massage is of inferior quality, such as exceptional high intensity of bacteria, people might not achieve their original goal when deciding to receive some hydrotherapy.

Moreover, to improve the quality of water, a spa bathtub which is capable of adding ozone into water in order to improve the water quality has been introduced. However, safety concern arising out of the usage of electrical device in an environment that is so close to water has not been thoroughly addressed.

### SUMMARY OF THE INVENTION

Because of the aforementioned problems, the present invention discloses a water supply apparatus with anti-bacterial functions capable of providing multiple operating modes associated with hydrotherapy.

To achieve the mentioned purposes, a water supply apparatus of a hydrotherapy device is disclosed according to the present invention. The system includes a water outlet module, a motor, a control module, a first magnetic valve, an ozone module, a second magnetic valve, and a pressure switch.

The water outlet module has a micro-bubble generator and a spa nozzle, for outputting a water flow. The motor is coupled with the water outlet module, for retrieving a water from a water source and providing the water to the water outlet module. The control module is coupled with the motor, an AC power source, and a switching unit. The control module receives a switching signal from the switching unit, and an electric power transmitted from the AC power source for driving the motor according to the switching signal. And the first magnetic valve couples with the control module, the motor, and the water outlet module and is controlled by the control module for determining whether to transmit the water from the motor to the spa nozzle of the water outlet module.

Additionally, the ozone module is coupled with the control module, for generating ozone and disinfecting the water. The second magnetic valve couples with the control module and the ozone module, and is controlled by the control module for determining whether to transmit the ozone. And, the pressure switch is coupled with the control module and the motor, for detecting the pressure of water outlet of the motor. If the pressure of the water outlet of the motor is low, which is indicative of the motor does not successfully retrieve the water, the control module may stop the motor from working.

Furthermore, the control module as described above is controlled by the switching unit, in order to determine whether to use the spa nozzle or the micro-bubble generator to output the water flow. Thus, by operating the switching unit, operation modes of the water supply apparatus could be determined.

And, the control module can further include a leakage detection unit and an overload detection unit, in order to detect a power leakage and a power overload. Additionally, the water supply apparatus may have a throttle unit coupled with the second magnetic valve and the motor, for controlling the output of the generated ozone. Thus, the appropriate amount of the ozone can be added into water in order to disinfect the water.

Moreover, the water supply apparatus can further include at least one drain valve, which is coupled with the motor and the water outlet module, for draining the water remaining in the pipes of the water supply apparatus. A strainer is installed associated with the water source for filtering the water to the motor. Thus, the strainer can prevent the pipes of the water supply apparatus from being clogged with hairs or dirt. And, the water supply system can further include a strainer detection unit for detecting whether the strainer is installed at the water source properly.

The water supply apparatus of the present invention can output good quality water by adding the ozone. And, the water supply apparatus is capable of detecting the power leakage and the power overload, enhancing the safety when the water supply apparatus is in use. Furthermore, the water supply apparatus can switch among at least two operation modes.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a block diagram of a water supply apparatus of a hydrotherapy system according to one embodiment of the present invention;

FIG. 2 is a block diagram of a water supply apparatus according to one embodiment of the present invention;

FIG. 3 is a schematic diagram of a water supply apparatus operating in a spa operation mode according to one embodiment of the present invention; and

FIG. 4 is a schematic diagram of a water supply apparatus operating in a micro-bubble mode according to one embodiment of the present invention.

### DETAILED DESCRIPTION OF THE PREFERRED EMBODIMENTS

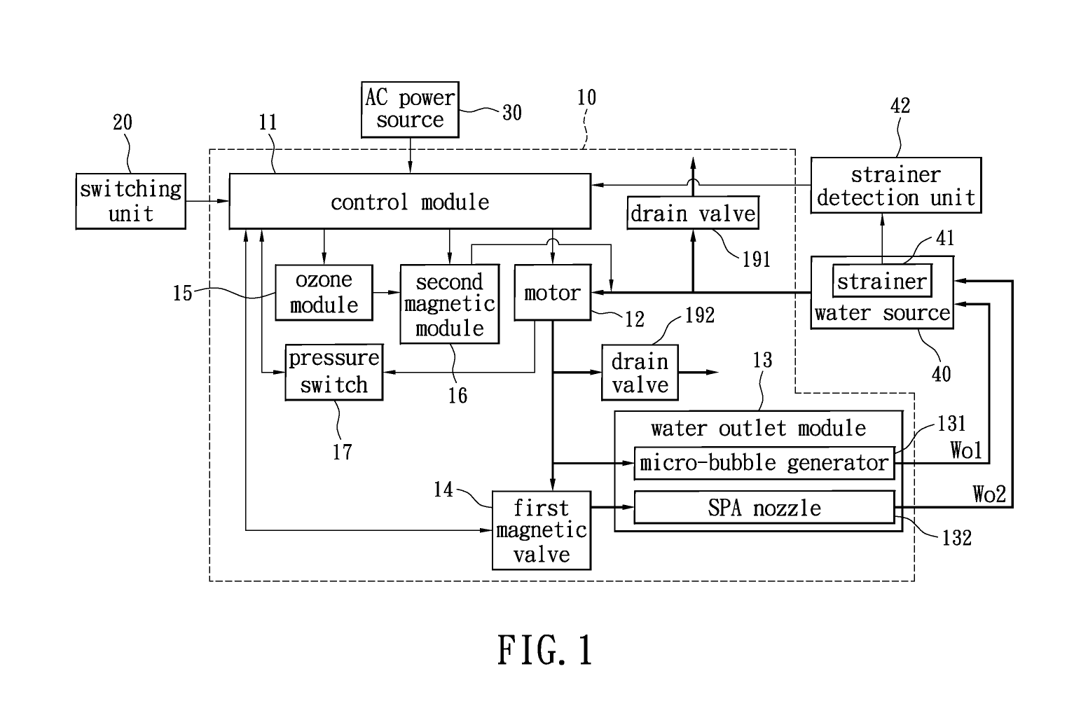

Please refer to FIG. 1, which is a bock diagram of a water supply apparatus 10 of hydrotherapy system according to one embodiment of the present invention. It is worth noting that the thick lines in FIG. 1 and subsequent figures indicate “water flow connections,” and the thin lines indicate “electrical connections.” The water supply apparatus 10 includes a control module 11, a motor 12, a water outlet module 13, a first magnetic valve 14, an ozone module 15, a second magnetic valve 16, and a pressure switch 17.

The water outlet module 13 includes a micro-bubble generator 131 and a spa nozzle 132. The micro-bubble generator 131 is configured to add micro-bubbles into water for outputting water flow Wo1. The spa nozzle 132 is for outputting pressurized water flow Wo2. By the water outlet module 13, the water supply system 10 can output at least two different water flows.

The motor 12 is coupled to the control module 11, the water outlet module 13, and the first magnetic valve 14. The motor 12 is configured to retrieve water from a water source 40, and transmits the retrieved water to the micro-bubble generator 131 or the spa nozzle 132 according to a control signal received from the control module 11. The control module 11 is also configured to transmit the power required for the motor 12 to function to the motor 12.

The ozone module 15 is coupled to the control module 11 and the second magnetic valve 16, for generating ozone that is capable of disinfecting the water flows. The control module 11 can control whether to transmit the generated ozone from the ozone module 15 to the water inlet of the motor 12 by opening or closing the second magnetic valve 16.

The control module 11 is the control center of the water supply apparatus 10 that controls signals, and is coupled to the motor 12, the first magnetic valve 14, the ozone module 15, the second magnetic valve 16, and the pressure switch 17. The control module 11 is further coupled to an alternating current (AC) power source 30 and a switching unit 20. The AC power source 30 is for providing requisite power to water supply apparatus 10, and the switching unit 20 is for setting the operation modes of the water supply apparatus 10.

Users can use the switching unit 20 to adjust the operating mode of the water supply apparatus 10 to choose between micro-bubbles and spa. The operation modes of the water supply apparatus 10 may at least include a micro-bubble mode and spa mode. After the control module 11 receives a switching signal from the switching unit 20, the control module 11 then controls the first magnetic valve 14 and the second magnetic valve 16 according to the switching signal in order to switch among the operation modes.

For example, if the spa mode is selected the control module 11 will then turn on the first magnetic valve 14 but turn off the second magnetic valve 16. Thus, the water retrieved by the motor 12 can be transmitted to the spa nozzle 132 and the pressurized water flow Wo2 is outputted. On the other hand, if the micro-bubble mode is selected the control module 11 will then turn off the first magnetic valve 14 but turn on the second magnetic valve 16. Thus, the ozone generated by the ozone module 15 can be added into the water retrieved by the motor 12, and the water flow Wo1 will be outputted through micro-bubble generator 131.

It is worth noting that the water supply apparatus 10 is configured to create a smaller flow resistance associated with the water to the spa nozzle 132 when compared with that associated with the water to the micro-bubble generator 131. Therefore, when the first magnetic valve 14 is turned on most of the water transmitted from the motor 12 flows to the spa nozzle 132. As such, the water supply apparatus 10 does not require another magnetic valve between the motor 12 and the micro-bubble generator 132.

Additionally, the water supply system 10 can further include a pressure switch 17 which is coupled to the motor 12 and the control module 11. The pressure switch 17 is for detecting the pressure of the water outlet of the motor 12, in order to ensure that the motor 12 retrieves the water successfully. If the detection of the pressure of the water outlet indicates that the motor 12 does not retrieve the water properly, the control module 11 then stops the motor 12 from operating. Thus, the consumption of the water may be reduced when the water retrieval of the motor 12 is not as desired while the integrity of the whole operation of the water supply apparatus 10 may be maintained.

Moreover, the water supply apparatus 10 may further include drain valves 191 and 192 coupled to water pipes of the water supply apparatus 10. After the operation mode of the water supply apparatus 10 is selected, the drain valve 191 and 192 may drain the water remaining in the water pipes before the operation of the water supply apparatus 10.

The water may be recycled in the water supply apparatus 10. More specifically, the water source 40 may come from the water in a bathtub, so that the water flows Wo1 and Wo2 that are sent to the bathtub may serve as the water source from which the motor 12 could retrieve before preparing the water to the water outlet module 13.

Considering the water may be recycled, the water supply apparatus 10 may further include a strainer 41 associated with the water source 40. With the strainer 41, the water flows may be filtered before being recycled as the water source 40. Consequently, dirt and/or hairs from the water flows may be stopped from entering into the pipes in order to minimize the occurrence of clogging. Additionally, the water supply system may include a strainer detection unit 42, for determining whether the strainer 41 is installed at the water source 40 or not. If the strainer 41 is not installed properly, the strainer detection unit 42 then sends a signal to the control module 11 for stopping the water supply apparatus 10 from operating.

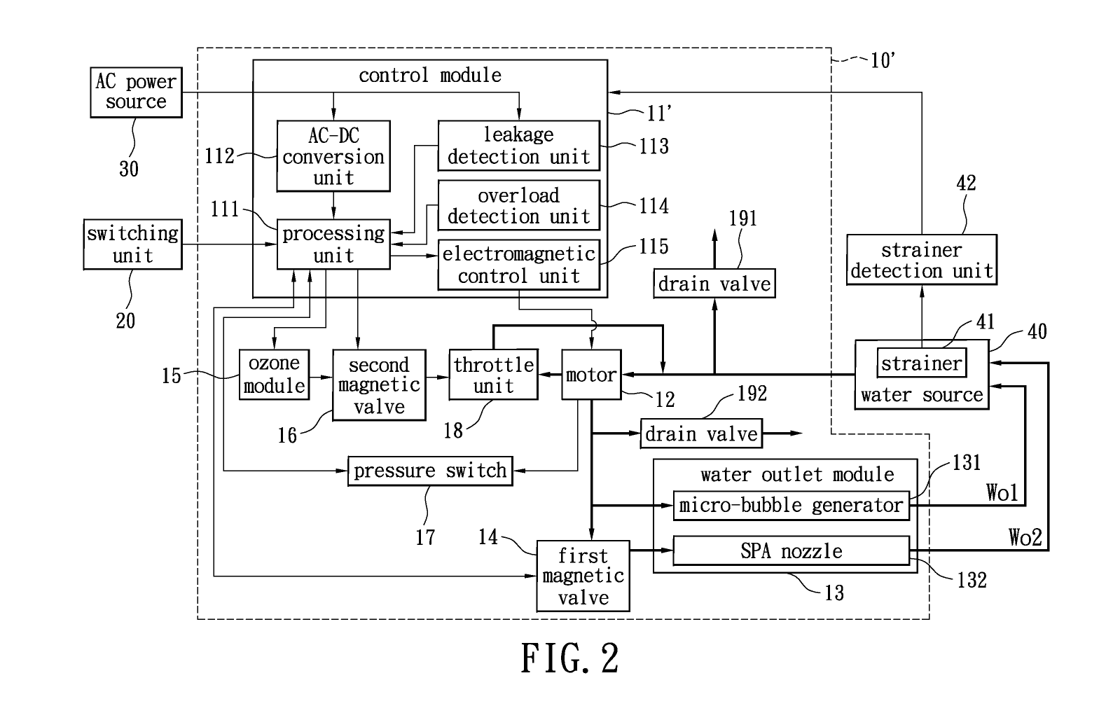

Please refer to FIG. 2 of a block diagram of a water supply apparatus 10′ according to one embodiment of the present invention. The differences between FIGS. 1 and 2 is that the control module 11′ in FIG. 2 further includes a processing unit 111, an alternating current(AC)-direct current(DC) conversion unit 112, a leakage detection unit 113, an overload detection unit 114, and an electromagnetic control unit 115.

The processing unit 111 is for processing signals and controlling other components of the water supply apparatus 10′. The processing unit 111 is coupled to the first magnetic valve 14, the ozone module 15, the second magnetic valve 16, the pressure switch 17, the AC-DC conversion unit 112, the leakage detection unit 113, the overload detection unit 114, and the electromagnetic control unit 115.

The AC-DC conversion unit 112 is disposed between the AC power source 30 and the processing unit 111. The AC-DC conversion unit 112 is for converting the power provided by the AC power source 30 into a DC power, and sending the DC power to processing unit 111. Thus, the processing unit 111 may function properly with the requisite electrical power.

The leakage detection unit 113 is coupled to the AC power source 30 and the processing unit 111, for detecting a power leakage. For instance, if the input power is not equal to the output power, the power leakage may have taken place in the circuit. When the detection result indicates the occurrence of the power leakage, the leakage detection unit 113 then sends a signal to the processing unit 111 for cutting off the power supply.

The overload detection unit 114 is coupled to the AC power source 30 and the processing unit 111, for detecting a power overload. If the magnitude of power provided from the AC power source 30 is over a threshold value, the overload detection unit 114 sends a signal to the processing unit 111 for cutting off the power supply. Detecting the power leakage and power overload may provide the water supply apparatus 10′ with additional protection/safety measures.

The electromagnetic control unit 115 is coupled to the overload detection unit 114 and the processing unit 111. The electromagnetic control unit 115 is controlled by processing unit 111, and is configured to receive the power to drive the motor 12.

Additionally, the water supply apparatus 10′ further includes a throttle unit 18 coupled to the second magnetic valve 16 and the motor 12. The throttle unit 18 may be a Venturi tube for adjusting the amount of ozone added into water. The throttle unit 18 receives the water from the motor 12, mixes a proper amount of ozone with the received water, and then sends the water back to the water inlet of the motor 12. Thus, the motor 12 may output the ozonized water to the water outlet module 13.

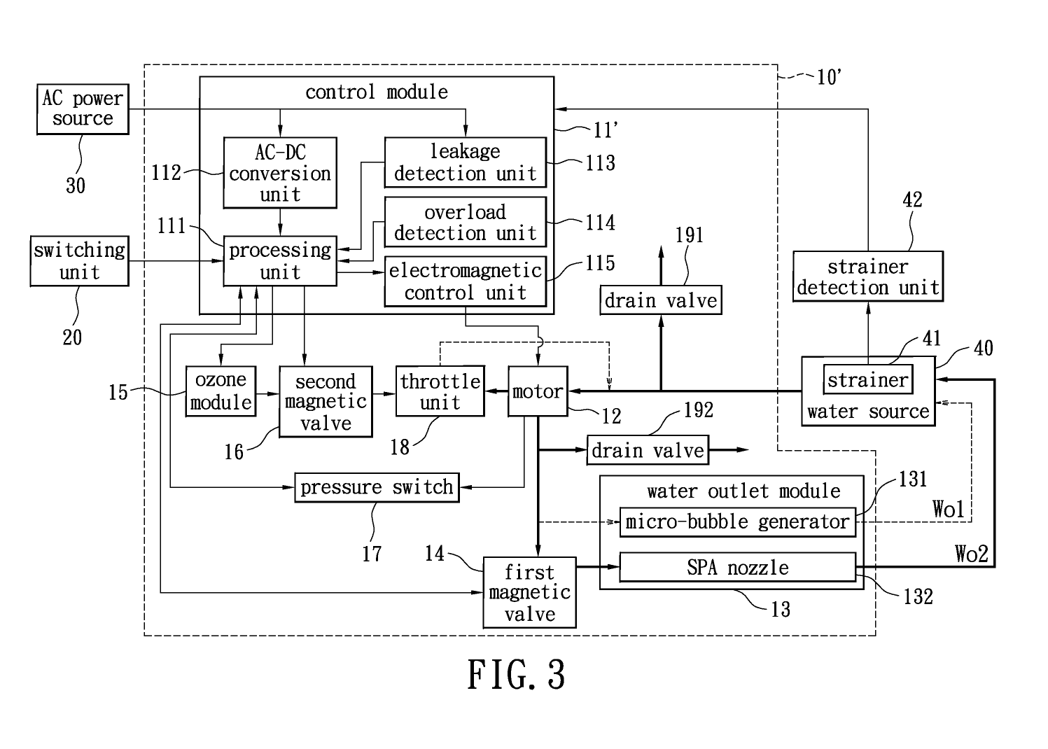

Please refer to FIG. 3 of a schematic diagram of a water supply apparatus 10′ operating in spa operation mode according to one embodiment of the present invention. As shown in the figure, the thick lines represent “water flow connections” and the thin lines represent “electrical connections.”

When the processing unit 111 receives the switching signal indicative of a selection of the spa mode, the drain valve 191 and 192 may drain the remaining water in the pipe lines, and the processing unit 111 then controls the electromagnetic control unit 115 to drive motor 12, in order to retrieve the water from water source 40. At the same time, the processing unit 111 turns on the first magnetic valve 14. Because the flow resistance associated with the water to the spa nozzle 132 is configured to be smaller than that associated with the water to the micro-bubble generator 131, when the first magnetic valve 14 is turned on most of the water flows to the spa nozzle 132. And thus the pressurized water flow Wo2 is outputted by the spa nozzle 132 with very little amount of water flowing to the micro-bubble generator 131.

When the water supply system 10′ operates in the spa mode, the pressure switch 17, the strainer detection unit 42, the leakage detection unit 113, and the overload detection unit 114 are still operating. Therefore, if the retrieved water is not enough, the strainer 41 does not installed at the water source 40 properly, or power leakage or power overload occurs, the processing unit 111 will cut the power off and deactivate the motor 12 for safety concern.

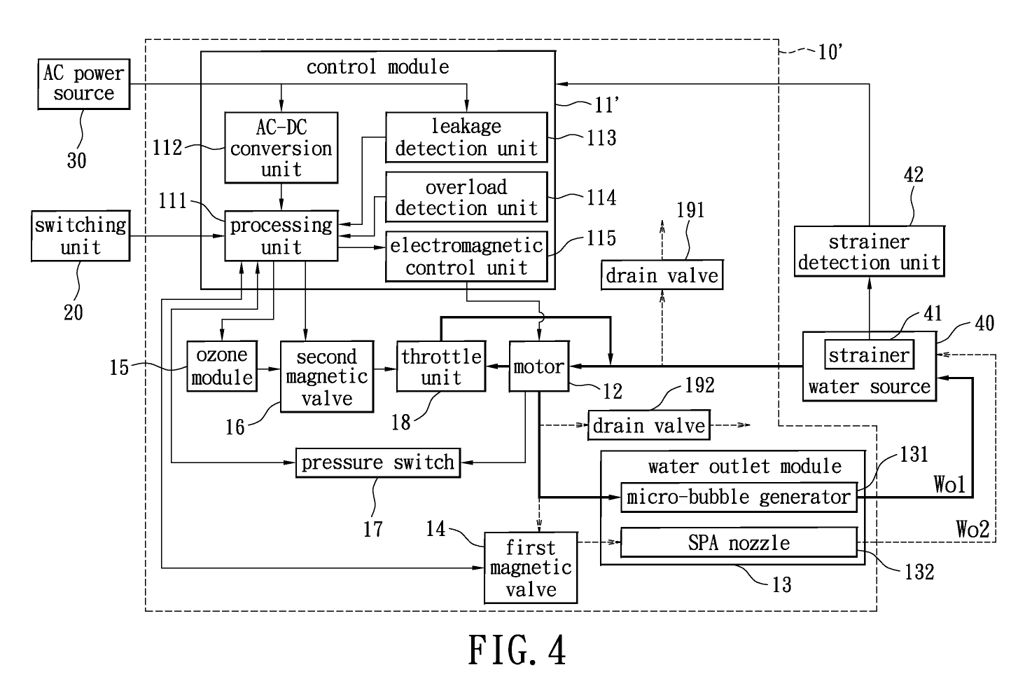

Please refer to FIG. 4 of a schematic diagram of a water supply apparatus 10′ operating in a micro-bubble mode according to one embodiment of the present invention. It is worth noting that operating modes of the water supply apparatus 10′ are switched in a predetermined sequence. For example, when to operate the water supply apparatus 10′ in the micro-bubble mode the switching unit 20 may switch the water supply apparatus 10′ into the spa mode, and then to the micro-bubble mode. Therefore, before the switching unit 20 switches the water supply apparatus 10′ into the micro-bubble mode, the drain valve 191 and 192 have already drained the remaining water in the pipe lines when the water supply apparatus 10′ still operates in the spa mode. When to operate the water supply apparatus 10′ in the micro-bubble mode, the processing unit 111 turns off the first magnetic valve 14, in order to transmit the water from the motor 12 to the micro-bubble generator 131.

Specifically, the ozone module 15 is configured to operate when the water supply apparatus 10′ is in the micro-bubble mode. At the same time, the processing unit 111 controls the second magnetic valve 16 for determining whether to add the generated ozone into water. Additionally, the throttle unit 18 is for adjusting the amount of ozone added into the water, and for mixing the water with the generated ozone. The ozonized water is then transmitted to the water inlet of the motor 12, so that the motor 12 can send the ozonized water to the micro-bubble generator 131. Thus, the micro-bubble generator 131 generates the micro-bubbles with the ozonized water, and outputs the water flow Wo1. In doing so, the water supply apparatus 10′ may enhance the quality of the water flow Wo1.

As described above, the quality of the water flow and the safety can be improved through the water supply apparatus of the present invention. Furthermore, by providing spa mode and micro-bubble mode through one single motor the water supply apparatus of the present invention could satisfy increased demands from the consumers.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. A water supply apparatus of a hydrotherapy system, comprising:
a water outlet module having a micro-bubble generator and a spa nozzle;
a motor coupled to the water outlet module for retrieving a water from a water source and supplying the water to the water outlet module;
a control module coupled to the motor, an alternating current (AC) power source, and a switching unit, wherein the control module transmits an electric power from the AC power source to the motor, in order to drive the motor;
a first magnetic valve coupled to the control module, the motor, and the water outlet module, wherein the first magnetic valve is controlled by the control module for determining whether to transmit the water from the motor to the spa nozzle;
an ozone module coupled to the control module for generating an ozone;
a second magnetic valve coupled to the control module and the ozone module, wherein the second magnetic valve is controlled by the control module for determining whether to transmit the ozone or not; and
a pressure switch coupled to the control module and the motor for detecting a pressure of the water source;
wherein the control module determines whether to enable the micro-bubble generator or the spa nozzle to output a water flow according to a switching signal generated by the switching unit.

2. The water supply apparatus as in claim 1, wherein the micro-bubble generator is coupled to the motor for receiving the water from the motor before generating micro-bubbles.

3. The water supply apparatus as in claim 1, wherein the spa nozzle is coupled to the first magnetic valve for receiving the water from the motor before outputting a pressurized water flow.

4. The water supply apparatus as in claim 1, wherein a flow resistance associated with the water transmitted to the spa nozzle is smaller than a flow resistance associated with the water transmitted to the micro-bubble generator.

5. The water supply apparatus as in claim 1, wherein the control module includes:
a leakage detection unit coupled to the AC power source for detecting a power leakage.

6. The water supply apparatus as in claim 1, wherein the control module further includes:
an overload detection unit coupled to the AC power source for detecting a power overload.

7. The water supply apparatus as in claim 1, further comprising:
a throttle unit coupled to the second magnetic valve and the motor for adjusting an amount of the ozone.

8. The water supply apparatus as in claim 7, wherein the throttle unit includes a Venturi tube.

9. The water supply apparatus as in claim 1, wherein the motor retrieves the water from the water source, and the water source is associated with a strainer for filtering the water sent to the motor.

10. The water supply apparatus as in claim 9, further comprising:
a strainer detection unit coupled to the water source for determining whether the strainer is installed at the motor or not.

11. The water supply apparatus as in claim 1, further comprising:
at least one drain valve coupled to the motor and the water outlet module for draining water in a pipe.

12. A water supply apparatus of a hydrotherapy device, comprising:
a water outlet module having a micro-bubble generator and a spa nozzle;
a motor coupled to the water outlet module for retrieving a water from a water source and transmitting the water to the water outlet module;
a control module coupled to the motor, an AC power source, and a switching unit, wherein the control module transmits an electric power received from the AC power source to the motor, in order to drive the motor, and the control module includes:
a processing unit coupled to the switching unit for processing signals;
an alternating current (AC)-direct current (DC) conversion unit coupled to the AC power source and the processing unit for converting the electric power into a DC power, and providing the DC power to the processing unit;
a leakage detection unit coupled to the processing unit and the AC power source for detecting a power leakage;
an overload detection unit coupled to the processing unit and the AC power source for detecting a power overload;
an electromagnetic control unit coupled to the processing unit, the motor, and the overload detection unit, and controlled by the processing unit for driving the motor;
a first magnetic valve coupled to the control module, the motor, and the water outlet module, and controlled by the control module for determining whether to transmit the water from the motor to the spa nozzle;
an ozone module coupled to the control module for generating an ozone;
a second magnetic valve coupled to the control module and the ozone module, and controlled by the control module in order to control transmission of the ozone; and
a pressure switch coupled to the control module and the motor for detecting pressure of water outlet of the motor;
wherein the control module determines whether to use the micro-bubble generator or the spa nozzle for outputting a water flow according to a switching signal generated by the switching unit.

13. The water supply apparatus as in claim 12, wherein the micro-bubble generator couples with the motor for receiving the water from the motor and generating micro-bubbles.

14. The water supply apparatus as in claim 12, wherein the spa nozzle couples with the first magnetic valve for receiving the water from the motor, and outputting a pressurized water flow.

15. The water supply apparatus as in claim 12, wherein a flow resistance associated with the water transmitted to the spa nozzle is smaller than a flow resistance associated with the water transmitted to the micro-bubble generator.

16. The water supply apparatus as in claim 12, further comprising:
a throttle unit coupled to the second magnetic valve and the motor for adjusting an amount of the ozone.

17. The water supply apparatus as in claim 16, wherein the throttle unit includes a Venturi tube.

18. The water supply apparatus as in claim 12, wherein the motor retrieves the water from the water source, and the water source is associated with a strainer for filtering the water.

19. The water supply apparatus as in claim 18, further comprising:
a strainer detection unit coupled to the water source for determining whether the strainer is installed at the motor or not.

20. The water supply apparatus as in claim 12, further comprising:
at least one drain valve coupled to the motor and the water outlet module for draining water in a pipe.
